(19) United States
(12) Patent Application Publication
(10) Pub. No.: US 2025/0315511 A1
(43) Pub. Date: Oct. 9, 2025

(54) REAL-PERSON IDENTITY VERIFICATION FOR NON-NATURAL PERSON ENTITY OPERATOR

(71) Applicant: Alipay (Hangzhou) Information Technology Co., Ltd., Hangzhou (CN)

(72) Inventor: Jun XIA, Hangzhou (CN)

(21) Appl. No.: 18/873,231

(22) PCT Filed: May 19, 2023
(86) PCT No.: PCT/CN2023/095218

§ 371 Date: Dec. 9, 2024

(30) Foreign Application Priority Data
Jun. 30, 2022 (CN) 202210767253.6

(51) Int. Cl. G06F 21/32; G06V 40/16

(52) U.S. Cl. CPC G06F 21/32; G06V 40/172

(57) ABSTRACT

The present disclosure provides a real-person identity verification method and system for a non-natural person entity operator. The method includes: receiving a service request of the non-natural person entity operator; obtaining personal identity information of the non-natural person entity operator based on the service request, to perform personal identity verification; obtaining and recognizing a document photo of a non-natural person entity in response to that personal identity verification succeeds, to perform non-natural person entity identity verification; in response to that the non-natural person entity identity verification succeeds, confirming that the non-natural person entity operator obtains authorization from the non-natural person entity; and performing a risk release on the service request based on the authorization confirmation.

### TECHNICAL FIELD

The present disclosure relates to the identity verification field, and more specifically, to real-person identity verification for a non-natural person entity operator.

### BACKGROUND

At present, with development of enterprise electronics, security of an enterprise account becomes more important. In the past system process, an enterprise has a set of accounts such as a bank account and a social security account on behalf of the enterprise in various fields or units. The accounts are usually grasped by a financial person or a legal person of a company and used for a daily service. When an enterprise person moves frequently or original information of the enterprise is partially lost, for example, when an enterprise account changes, it becomes very complex and cumbersome if an identity of an enterprise operator needs to be verified.

In addition, most current systems perform verification by sending an OTP random verification code to a registered mailbox. In this way, a security level is relatively low, the mailbox is easily broken, and a password of the enterprise account is easily changed. In addition, mailboxes or mobile phone numbers used when many small and medium-sized enterprises are registered cannot be traced in actual services. In this case, if a user initiates a password change, a failure may be caused because no identity verification product is available or a mailbox or a mobile phone verification code cannot be entered.

At present, although there are some enterprise operator identity verification means, identity verification means that exist currently are that an enterprise operator uploads some materials of a representative enterprise of the enterprise operator and then performs manual review. However, the materials for manual review may be forged, this can be hardly found during manual review, and the manual review has a cumbersome procedure and a long time, wasting manpower resources.

Therefore, it is expected to provide a real-person identity verification method for an enterprise operator. Real-person identity verification of the enterprise operator is automatically completed through enterprise document photo recognition and facial recognition, to reduce instability and wrong determining of manual recognition. Manual intervention does not need to be performed, to improve enterprise identity verification efficiency, and improve user experience.

### SUMMARY

Content of the present disclosure is provided, to describe, in a simplified form, some concepts that are to be further described in the following specific implementations. The content of the present disclosure is neither intended to identify key features or necessary features of the claimed subject matter, nor intended to help determine the scope of the claimed subject matter.

For the above-mentioned problems, according to an aspect of the present disclosure, a real-person identity verification method for a non-natural person entity operator is provided. The method includes: receiving a service request of the non-natural person entity operator; obtaining personal identity information of the non-natural person entity operator based on the service request, to perform personal identity verification; obtaining and recognizing a document photo of a non-natural person entity in response to that personal identity verification succeeds, to perform non-natural person entity identity verification; in response to that the non-natural person entity identity verification succeeds, confirming that the non-natural person entity operator obtains authorization from the non-natural person entity; and performing a risk release on the service request based on the authorization confirmation.

In the technical solution of this embodiment of the present disclosure, a facial recognition and ID authentication manner is applied to non-natural person entity identity verification (for example, an enterprise). Operator information (for example, legal person information in a business license) in the document photo is recognized, and whether a user of a current operation is a legal person/authorized operator in the business license is recognized through facial recognition and ID authentication, to release a risk of the enterprise, so that a scenario service such as an enterprise information change is completed quickly, securely, and at low costs, user experience is improved, and an input of manpower resources of a service provider is significantly reduced.

According to an embodiment of the present disclosure, the confirming that the non-natural person entity operator obtains authorization from the non-natural person entity further includes: comparing personal identity information of an authorized non-natural person entity operator recognized from the document photo and the personal identity information of the non-natural person entity operator; and in response to that a comparison result is that the personal identity information of the authorized non-natural person entity operator recognized from the document photo and the personal identity information of the non-natural person entity operator are consistent, confirming that the non-natural person entity operator obtains authorization from the non-natural person entity.

According to a further embodiment of the present disclosure, the obtaining personal identity information of the non-natural person entity operator, to perform personal identity verification further includes: capturing face information and identity document information of the non-natural person entity operator by using a camera, and transferring the face information and the identity document information to an identity verification server; and performing a three-way comparison on the captured face information, face information extracted from the identity document information, and face information stored in the identity verification server, to perform personal identity verification.

According to a further embodiment of the present disclosure, the obtaining and recognizing a document photo of a non-natural person entity, to perform non-natural person entity identity verification further includes: capturing the document photo of the non-natural person entity by using a camera, and transferring the document photo to an identity verification server; performing anti-counterfeiting detection and content recognition on the document photo in the identity verification server, to obtain non-natural person entity document information; and comparing the obtained non-natural person entity document information and non-natural person entity document information stored in the identity verification server, to perform non-natural person entity verification.

According to a further embodiment of the present disclosure, the performing content recognition on the document photo, to obtain non-natural person entity document information further includes: performing optical character recognition and official seal recognition on the document photo, to obtain the non-natural person entity document information.

According to a further embodiment of the present disclosure, the method further includes: binding, based on the authorization confirmation, the obtained personal identity information of the non-natural person entity operator to non-natural person entity document information recognized from the document photo of the non-natural person entity, and storing the obtained personal identity information and the non-natural person entity document information in the identity verification server.

According to a further embodiment of the present disclosure, the document photo includes a business license photo, and the comparing personal identity information of an authorized non-natural person entity operator recognized from the document photo and the personal identity information of the non-natural person entity operator further includes: comparing a legal person name recognized from the business license photo and a name extracted from the personal identity information of the non-natural person entity operator.

According to a further embodiment of the present disclosure, the document photo includes a business license photo and an authorization document photo, and the comparing personal identity information of an authorized non-natural person entity operator recognized from the document photo and the personal identity information of the non-natural person entity operator further includes: comparing a non-natural person entity name recognized from the authorization document photo and a non-natural person entity name recognized from the business license photo; if the non-natural person entity names are consistent, performing anti-counterfeiting verification on a non-natural person entity official seal recognized from the authorization document photo; and if an anti-counterfeiting verification result is “true”, comparing a name of an authorized non-natural person entity operator recognized from the authorization document photo and a name extracted from the personal identity information of the non-natural person entity operator.

According to a further embodiment of the present disclosure, the method further includes: performing secondary identity verification in response to the authorization confirmation and the non-natural person entity operator continues a service operation.

According to another aspect of the present disclosure, a real-person identity verification system for a non-natural person entity operator is provided. The system includes: a personal identity verification module, configured to: receive a service request of the non-natural person entity operator; and obtain personal identity information of the non-natural person entity operator in response to the service request, to perform personal identity verification; a non-natural person entity identity verification module, configured to obtain and recognize a document photo of a non-natural person entity in response to that personal identity verification succeeds, to perform non-natural person entity identity verification; and a risk release module, configured to: in response to that the non-natural person entity identity verification succeeds, confirm that the non-natural person entity operator obtains authorization from the non-natural person entity; and perform a risk release on the service request based on the authorization confirmation.

In the technical solution of this embodiment of the present disclosure, the real-person identity verification system for a non-natural person entity operator can automatically complete real-person identity verification of an enterprise operator through enterprise document photo recognition and personal identification, to reduce instability and wrong determining of manual recognition, improve enterprise identity verification efficiency, and improve user experience.

According to an embodiment of the present disclosure, the confirming that the non-natural person entity operator obtains authorization from the non-natural person entity further includes: comparing personal identity information of an authorized non-natural person entity operator recognized from the document photo and the personal identity information of the non-natural person entity operator; and in response to that a comparison result is that the personal identity information of the authorized non-natural person entity operator recognized from the document photo and the personal identity information of the non-natural person entity operator are consistent, confirming that the non-natural person entity operator obtains authorization from the non-natural person entity.

According to a further embodiment of the present disclosure, the obtaining personal identity information of the non-natural person entity operator, to perform personal identity verification further includes: capturing face information and identity document information of the non-natural person entity operator by using a camera, and transferring the face information and the identity document information to an identity verification server; and performing a three-way comparison on the captured face information, face information extracted from the identity document information, and face information stored in the identity verification server, to perform personal identity verification.

According to a further embodiment of the present disclosure, the obtaining and recognizing a document photo of a non-natural person entity, to perform non-natural person entity identity verification further includes: capturing the document photo of the non-natural person entity by using a camera, and transferring the document photo to an identity verification server; performing anti-counterfeiting detection and content recognition on the document photo in the identity verification server, to obtain non-natural person entity document information; and comparing the obtained non-natural person entity document information and non-natural person entity document information stored in the identity verification server, to perform non-natural person entity verification.

According to a further embodiment of the present disclosure, the performing content recognition on the document photo, to obtain non-natural person entity document information further includes: performing optical character recognition and official seal recognition on the document photo, to obtain the non-natural person entity document information.

According to a further embodiment of the present disclosure, the risk release module is further configured to: bind, based on the authorization confirmation, the obtained personal identity information of the non-natural person entity operator to non-natural person entity document information recognized from the document photo of the non-natural person entity, and store the obtained personal identity information and the non-natural person entity document information in the identity verification server.

According to a further embodiment of the present disclosure, the document photo includes a business license photo, and the comparing personal identity information of an authorized non-natural person entity operator recognized from the document photo and the personal identity information of the non-natural person entity operator further includes: comparing a legal person name recognized from the business license photo and a name extracted from the personal identity information of the non-natural person entity operator.

According to a further embodiment of the present disclosure, the document photo includes a business license photo and an authorization document photo, and the comparing personal identity information of an authorized non-natural person entity operator recognized from the document photo and the personal identity information of the non-natural person entity operator further includes: comparing a non-natural person entity name recognized from the authorization document photo and a non-natural person entity name recognized from the business license photo; if the non-natural person entity names are consistent, performing anti-counterfeiting verification on a non-natural person entity official seal recognized from the authorization document photo; and if an anti-counterfeiting verification result is “true”, comparing a name of an authorized non-natural person entity operator recognized from the authorization document photo and a name extracted from the personal identity information of the non-natural person entity operator.

According to a further embodiment of the present disclosure, the risk release module is further configured to perform secondary identity verification in response to the authorization confirmation and the non-natural person entity operator continues a service operation.

According to still another aspect of the present disclosure, a non-transitory computer-readable storage medium storing instructions is provided. When the instructions are executed, a machine is enabled to perform the method in any of the above-mentioned aspects.

These and other features and advantages become clear by reading the following detailed descriptions and with reference to the associated accompanying drawings. It should be understood that the above-mentioned general descriptions and the following detailed descriptions are merely illustrative, and do not limit the aspects that claim protection.

### BRIEF DESCRIPTION OF DRAWINGS

To understand in detail the manners used by the above-mentioned features of the present disclosure, references can be made to the embodiments for more specific descriptions of the above-mentioned briefly and generally described content, and some aspects are shown in the accompanying drawings. However, it should be noted that the accompanying drawings show only some typical aspects of the present disclosure, and therefore should not be construed as limiting the scope thereof, because the descriptions can be allowed to have other equivalent aspects.

FIG. 1 is a schematic architectural diagram of a real-person identity verification system for a non-natural person entity operator according to an embodiment of the present disclosure;

FIG. 2 is a timing diagram of real-person identity verification of an enterprise operator according to an embodiment of the present disclosure;

FIG. 3 is a schematic diagram of identity document recognition and enterprise document recognition according to an embodiment of the present disclosure;

FIG. 4 is a schematic flowchart of a real-person identity verification method for a non-natural person entity operator according to an embodiment of the present disclosure; and

FIG. 5 is a schematic architectural diagram of a real-person identity verification system for a non-natural person entity operator according to an embodiment of the present disclosure.

### DESCRIPTION OF EMBODIMENTS

The following describes the present disclosure in detail with reference to the accompanying drawings, and features of the present disclosure are further shown in the following specific descriptions.

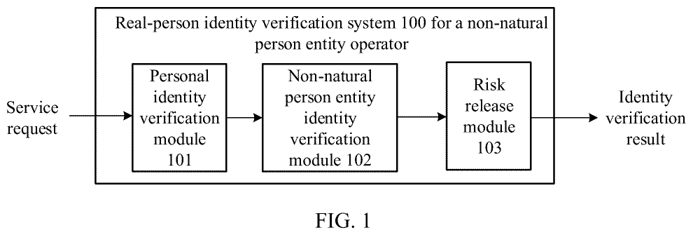

FIG. 1 is a schematic architectural diagram of a real-person identity verification system 100 for a non-natural person entity operator according to an embodiment of the present disclosure. The system 100 can include at least a personal identity verification module 101, a non-natural person entity identity verification module 102, and a risk release module 103.

The personal identity verification module 101 can receive a service request of a non-natural person entity operator, and obtain personal identity information of the non-natural person entity operator in response to the service request, to perform personal identity verification. In an implementation, the personal identity verification module 101 can capture face information and identity document information of the non-natural person entity operator by using a camera, and transfer the face information and the identity document information to an identity verification server; and perform a three-way comparison on the captured face information, face information extracted from the identity document information, and face information stored in the identity verification server, to perform personal identity verification. In this way, personal identity verification is implemented through facial recognition and ID authentication.

The non-natural person entity identity verification module 102 can obtain and recognize a document photo of a non-natural person entity in response to that personal identity verification succeeds, to perform non-natural person entity identity verification. In an implementation, the non-natural person entity identity verification module 102 can capture the document photo of the non-natural person entity by using a camera, and transfer the document photo to an identity verification server; perform anti-counterfeiting detection and content recognition (for example, optical character recognition and official seal recognition) on each document photo in the identity verification server, to obtain non-natural person entity document information; and compare the obtained non-natural person entity document information and non-natural person entity document information stored in the identity verification server, to perform non-natural person entity verification. The document photo of the non-natural person entity can include, for example, a business license photo and an authorization document photo that represent an identity of the non-natural person entity.

In response to that the non-natural person entity identity verification succeeds, the risk release module 103 can confirm that the non-natural person entity operator obtains authorization from the non-natural person entity. In an implementation, the risk release module 103 can learn, through comparison, of whether personal identity information of an authorized non-natural person entity operator recognized from the document photo and the personal identity information of the non-natural person entity operator are consistent, so that after the personal identity verification and the non-natural person entity identity verification are completed, whether a current operator is an operator authorized by the non-natural person entity or a non-natural person entity legal person is further determined. In an implementation, when the document photo includes a business license photo, the above-mentioned identity verification process of the authorized non-natural person entity operator can be implemented by learning, through comparison, of whether a legal person name recognized from the business license photo and a name extracted from the personal identity information of the non-natural person entity operator are consistent. In another implementation, when the document photo includes a business license photo and an authorization document photo, the above-mentioned identity verification process of the authorized non-natural person entity operator can be implemented by using the following operations: learning, through comparison, of whether a non-natural person entity name recognized from the authorization document photo and a non-natural person entity name recognized from the business license photo are consistent; if the non-natural person entity names are consistent, performing anti-counterfeiting verification on a non-natural person entity official seal recognized from the authorization document photo; and if an anti-counterfeiting verification result is “true”, learning, through comparison, of whether a name of an authorized non-natural person entity operator recognized from the authorization document photo and a name extracted from the personal identity information of the non-natural person entity operator are consistent. If the names are consistent, identity verification succeeds. In a further implementation, the risk release module 103 can further bind, during the authorization confirmation, the obtained personal identity information of the non-natural person entity operator to non-natural person entity document information recognized from the document photo of the non-natural person entity, and store the obtained personal identity information and the non-natural person entity document information in the identity verification server. In a further implementation, the risk release module 103 can further perform secondary identity verification in response to the authorization confirmation and the non-natural person entity operator continues a service operation.

A person skilled in the art can understand that the system and the modules of the system in the present disclosure can be implemented in a hardware form or in a software form, and the modules can be combined in any proper manner. In addition, the system in the present disclosure can be implemented on a smart device, and the smart device can include but is not limited to a smartphone, a mobile phone, a smart watch, or a wearable device. In addition, for clarity, the following describes the above-mentioned non-natural person entity by using an enterprise as an example.

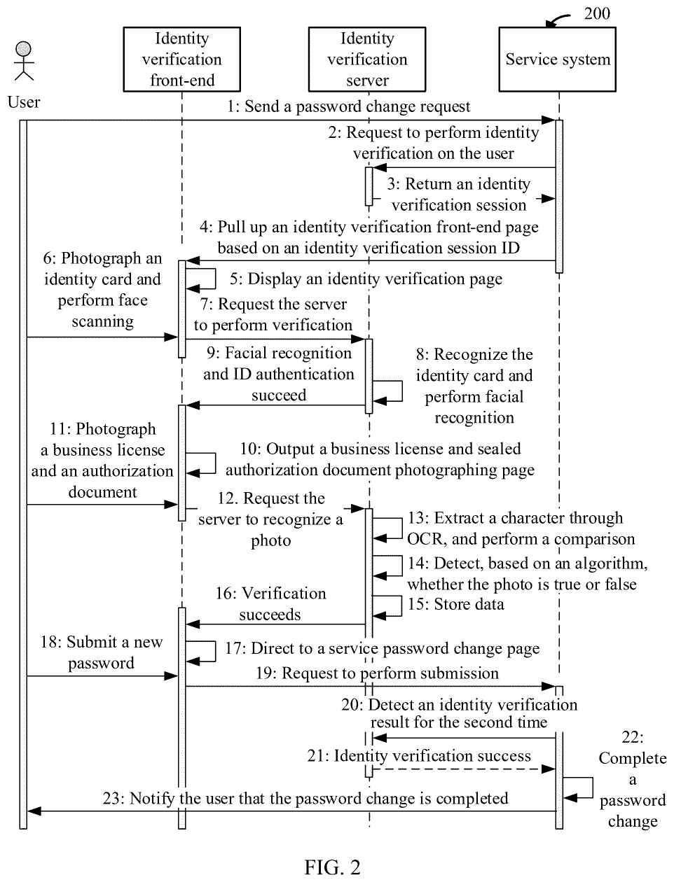

FIG. 2 is a timing diagram of real-person identity verification of an enterprise operator according to an embodiment of the present disclosure.

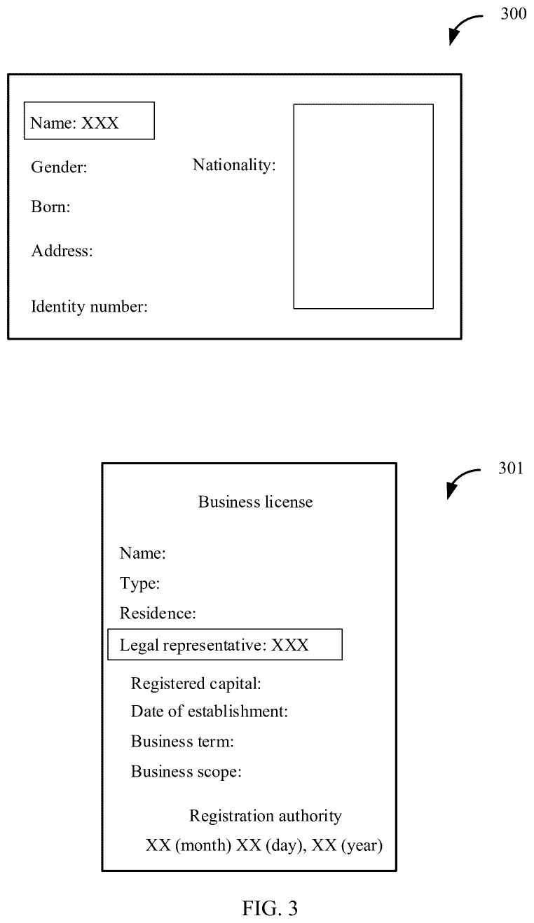

In FIG. 2, Step 1: A user initiates a service request for changing an enterprise account password. Step 2: A service system subsequently invokes an identity verification system, to perform identity verification on the user. Step 3: After receiving a user request, the identity verification system initializes a current identity verification session, and returns the identity verification session to a service system. Step 4: A service front-end system pulls up an identity verification front-end sdk based on an identity verification session ID. Step 5: The identity verification front-end sdk displays an identity verification page based on the identity verification session ID, and requires the user to perform an operation based on a prompt. Step 6: The user photographs an identity document and performs facial recognition based on a prompt. Step 7: The identity verification front-end sdk transfers received identity document information and received face information to an identity verification server, to request the server to perform personal identity verification. Step 8: The identity verification server recognizes the identity document information, performs facial recognition, and performs a three-way comparison with face information stored in the identity verification server, to perform facial recognition and ID authentication. As shown in 300 in FIG. 3, recognized personal identity document information includes a name, a gender, an identity number, face information, etc. Step 9: Return a personal identity verification success result to the identity verification front-end sdk when facial recognition and ID authentication succeed. Step 10: The identity verification front-end sdk renders a business license and sealed authorization document photographing page in response to that facial recognition and document recognition succeed. Step 11: The user photographs the business license and the sealed authorization document based on a prompt. Step 12: The identity verification front-end sdk transfers a received enterprise document photo to the identity verification server, to request the identity verification server to recognize the document photo. Step 13: The identity verification server can perform content recognition (for example, optical character recognition and official seal recognition) on each received enterprise document photo (for example, a business license and an authorization document), to obtain enterprise document information, and compare the obtained enterprise document information and enterprise document information stored in the identity verification server, to perform enterprise identity verification. As shown in 301 in FIG. 3, recognized business license information includes, for example, a name, a type, a residence, a legal representative, etc. Step 14: The identity verification server can perform anti-counterfeiting detection on each received enterprise document photo based on an algorithm, to further implement enterprise identity verification. When the enterprise identity verification succeeds, whether personal identity information of an authorized enterprise operator recognized from the document photo and personal identity information of the user are consistent can be determined. If the personal identity information of the authorized enterprise operator recognized from the document photo and the personal identity information of the user are consistent, it is determined that the user is an operator authorized by an enterprise or an enterprise legal person. As shown in FIG. 3, whether the user is the operator (which is the enterprise legal person here) authorized by the enterprise can be determined by comparing a name extracted from an identity document and a name of a legal representative extracted from the business license. Step 15: Store, in the identity verification server, the enterprise document information obtained in step 13 and user identity information obtained in step 8. Step 16: The identity verification front-end sdk returns the identity verification success result of the authorized enterprise operator. Step 17: In response to that identity verification of the enterprise operator succeeds, redirect to a service password change page to continue a service operation. Step 18: The user submits a new password. Step 19: Submit the new password to the service system. Step 20: In response to that identity verification succeeds and the service operation is continued, request the identity verification system to detect an identity verification result for the second time. Step 21: The identity verification system returns a secondary identity verification success result to the service system.

Step 22: The service system completes a password change request. Step 23: The service system notifies the user that a password change is completed.

It can be learned from the above-mentioned enterprise account password change scenario that in this technical solution, identity verification of the authorized enterprise operator can be automatically completed when an enterprise account password is changed, without manual intervention. In this way, enterprise identity verification efficiency is significantly improved. In addition, facial recognition and document recognition are implemented based on an algorithm, to reduce instability and wrong determining of manual recognition. In addition, security in the technical solution is higher than that of a mailbox OTP, and a problem that a mailbox is easily broken is resolved.

In consideration of another scenario in the following, when enterprise legal person information needs to be changed, a unit such as a bank or a social security administration requires the enterprise operator to carry a document such as an enterprise seal or a business license to perform processing on a corresponding counter. This manner is cumbersome and has low efficiency. A change needs to be performed in many places. According to the technical solution in the present disclosure, manual intervention does not need to be performed, and real-person identity verification of the authorized enterprise operator can be completed by merely performing facial recognition and ID authentication based on an algorithm. This significantly improves identity verification security and user experience.

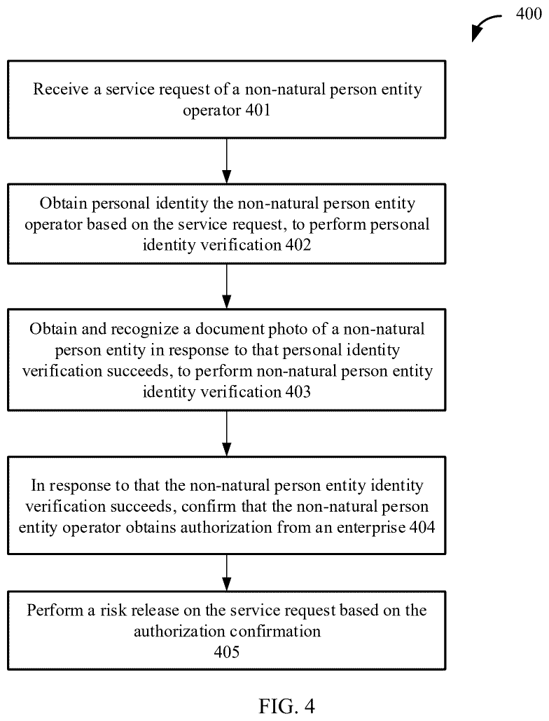

FIG. 4 is a schematic flowchart of a real-person identity verification method 400 for a non-natural person entity operator according to an embodiment of the present disclosure. The method 400 starts from step 401: A personal identity verification module 101 can receive a service request of the non-natural person entity operator.

Step 402: The personal identity verification module 101 can obtain personal identity information of the non-natural person entity operator in response to the service request, to perform personal identity verification. In an implementation, the personal identity verification module 101 can photograph the non-natural person entity operator and an identity document of the non-natural person entity operator by using a smart device, and send captured face information and captured identity document information to an identity verification server to perform further verification. Then, the identity verification server can perform a three-way comparison on the captured face information, face information extracted from the identity document information, and face information stored in the identity verification server, to perform personal identity verification. The three-way comparison is performed, to improve accuracy of personal identity verification and reduce a risk of a false document.

Step 403: A non-natural person entity identity verification module 102 can obtain and recognize a document photo of a non-natural person entity in response to that personal identity verification succeeds, to perform non-natural person entity identity verification. In an implementation, the non-natural person entity identity verification module 102 can photograph a non-natural person entity document (for example, a business license and a sealed authorization document) by using the smart device, and transfer the captured document photo to the identity verification server, to perform further verification; subsequently, can perform anti-counterfeiting detection and content recognition on each document photo in the identity verification server, to obtain non-natural person entity document information; and compare the obtained non-natural person entity document information and non-natural person entity document information stored in the identity verification server, to perform non-natural person entity verification. For example, the non-natural person entity identity verification module 102 can perform character recognition through OCR when each received document photo is recognized, and perform seal recognition, to obtain the non-natural person entity document information (for example, a name, a type, or a legal representative of the non-natural person entity).

Step 404: In response to that the non-natural person entity identity verification succeeds, a risk release module 103 can confirm that the non-natural person entity operator obtains authorization from the non-natural person entity. In an implementation, the risk release module 103 can compare personal identity information of an authorized non-natural person entity operator recognized from the document photo and the personal identity information of the non-natural person entity operator; and when a comparison result is that the personal identity information of the authorized non-natural person entity operator recognized from the document photo and the personal identity information of the non-natural person entity operator are consistent, confirm that the non-natural person entity operator obtains authorization from the non-natural person entity. In an implementation, the captured document photo of the non-natural person entity includes a business license photo; and the risk release module 103 can learn, through comparison when the personal identity verification and the non-natural person entity identity verification succeed, of whether a legal person name recognized from the business license photo and a name extracted from the personal identity information of the non-natural person entity operator are consistent; and if the names are consistent, determine that the non-natural person entity operator is an operator authorized by the non-natural person entity (that is, identity verification of the non-natural person entity operator succeeds). In another implementation, the captured document photo of the non-natural person entity includes a business license photo and an authorization document photo; and the risk release module 103 can learn, through comparison when the personal identity verification and the non-natural person entity identity verification succeed, of whether a non-natural person entity name recognized from the authorization document photo and a non-natural person entity name recognized from the business license photo are consistent; if the non-natural person entity names are consistent, perform anti-counterfeiting verification on a non-natural person entity official seal recognized from the authorization document photo; and if an anti-counterfeiting verification result is “true”, learn, through comparison, of whether a name of an authorized non-natural person entity operator recognized from the authorization document photo and a name extracted from the personal identity information of the non-natural person entity operator are consistent. If the names are consistent, identity verification of the non-natural person entity operator succeeds.

In step 405, the risk release module 103 can perform a risk release on the service request based on the authorization confirmation. Further, the risk release module 103 can perform secondary identity verification in response to the authorization confirmation and the non-natural person entity operator continues a service operation.

In this way, a facial recognition and ID authentication manner is applied to non-natural person entity identity verification. Operator information in the document photo is recognized, and whether a user of a current operation is an authorized operator or an enterprise legal person is recognized through facial recognition and ID authentication, to release a risk of the enterprise, so that a scenario service such as an enterprise information change is completed quickly, securely, and at low costs, user experience is improved, and an input of manpower resources of a service provider is reduced.

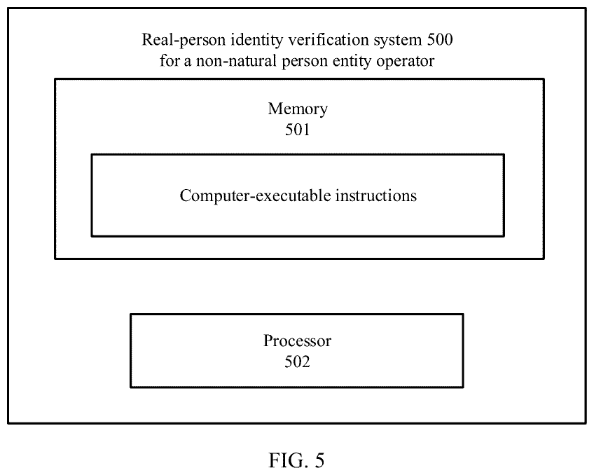

FIG. 5 is a schematic architectural diagram of a real-person identity verification system 500 for a non-natural person entity operator according to an embodiment of the present disclosure. As shown in FIG. 5, the system 500 can include a memory 501 and at least one processor 502. The memory 501 can include a RAM, a ROM, or a combination thereof. The memory 501 can store computer-executable instructions, and when the instructions are executed by the at least one processor 502, the at least one processor 502 performs various functions described in this specification, including: receiving a service request of the non-natural person entity operator; obtaining personal identity information of the non-natural person entity operator based on the service request, to perform personal identity verification; obtaining and recognizing a document photo of a non-natural person entity in response to that personal identity verification succeeds, to perform non-natural person entity identity verification; in response to that the non-natural person entity identity verification succeeds, confirming that the non-natural person entity operator obtains authorization from the non-natural person entity; and performing a risk release on the service request based on the authorization confirmation. In some cases, the memory 501 can particularly include a BIOS, and the BIOS can control basic hardware or software operations such as interaction with a peripheral component or device. The processor 502 can include a smart hardware device (for example, a general-purpose processor, a DSP, a CPU, a microcontroller, an ASIC, an FPGA, a programmable logic device, a discrete gate or transistor logic component, a discrete hardware component, or any combination thereof).

Various illustrative boxes and modules disclosed in this specification can be implemented or executed by a general-purpose processor, a DSP, an ASIC, an FPGA or another programmable logic device, a discrete gate or transistor logic component, a discrete hardware component, or any combination thereof designed to perform the functions described in this specification. The general-purpose processor can be a microprocessor, but in an alternative solution, the processor can be any conventional processor, controller, microcontroller, or state machine. The processor can also be implemented as a combination of computing devices (for example, a combination of a DSP and a microprocessor, a plurality of microprocessors, one or more microprocessors that cooperate with a core of a DSP, or any other such configuration).

The functions described in this specification can be implemented in hardware, software executed by the processor, firmware, or any combination thereof. If the functions are implemented in software executed by the processor, the functions can be stored as one or more instructions or code on a computer-readable medium or transmitted through a computer-readable medium. Other examples and implementations fall within the scope of the present disclosure and the appended claims. For example, due to the nature of software, the functions described in this specification can be implemented by using software executed by the processor, hardware, firmware, a hard link, or any combination thereof. Features that implement the functions can also be physically located at various locations, including being distributed, so that parts of the functions are implemented at different physical locations.

The content described above includes examples of aspects of the claimed subject matter. Certainly, it is impossible to describe a combination of components or methods that can be contemplated for the purpose of describing the claimed subject matter, but those of ordinary skill in the art should recognize that many further combinations and arrangements of the claimed subject matter are possible. Therefore, the disclosed subject matter is intended to cover all such changes, modifications, and variations that fall within the spirit and scope of the appended claims.

1. A real-person identity verification method for a non-natural person entity operator, wherein the method comprises:
receiving a service request of the non-natural person entity operator;
obtaining personal identity information of the non-natural person entity operator based on the service request, to perform personal identity verification;
obtaining and recognizing a document photo of a non-natural person entity in response to that personal identity verification succeeds, to perform non-natural person entity identity verification;
in response to that the non-natural person entity identity verification succeeds, confirming that the non-natural person entity operator obtains authorization from the non-natural person entity; and
performing a risk release on the service request based on the authorization confirmation.

2. The method according to claim 1, wherein the confirming that the non-natural person entity operator obtains authorization from the non-natural person entity further comprises:
comparing personal identity information of an authorized non-natural person entity operator recognized from the document photo and the personal identity information of the non-natural person entity operator; and
in response to that a comparison result is that the personal identity information of the authorized non-natural person entity operator recognized from the document photo and the personal identity information of the non-natural person entity operator are consistent, confirming that the non-natural person entity operator obtains authorization from the non-natural person entity.

3. The method according to claim 1, wherein the obtaining personal identity information of the non-natural person entity operator, to perform personal identity verification further comprises:
capturing face information and identity document information of the non-natural person entity operator by using a camera, and transferring the face information and the identity document information to an identity verification server; and
performing a three-way comparison on the captured face information, face information extracted from the identity document information, and face information stored in the identity verification server, to perform personal identity verification.

4. The method according to claim 1, wherein the obtaining and recognizing a document photo of a non-natural person entity, to perform non-natural person entity identity verification further comprises:
capturing the document photo of the non-natural person entity by using a camera, and transferring the document photo to an identity verification server;
performing anti-counterfeiting detection and content recognition on the document photo in the identity verification server, to obtain non-natural person entity document information; and
comparing the obtained non-natural person entity document information and non-natural person entity document information stored in the identity verification server, to perform non-natural person entity verification.

5. The method according to claim 4, wherein the performing content recognition on the document photo, to obtain non-natural person entity document information further comprises:
performing optical character recognition and official seal recognition on the document photo, to obtain the non-natural person entity document information.

6. The method according to claim 1, further comprising:
binding, based on the authorization confirmation, the obtained personal identity information of the non-natural person entity operator to non-natural person entity document information recognized from the document photo of the non-natural person entity, and storing the obtained personal identity information and the non-natural person entity document information in the identity verification server.

7. The method according to claim 2, wherein the document photo comprises a business license photo, and the comparing personal identity information of an authorized non-natural person entity operator recognized from the document photo and the personal identity information of the non-natural person entity operator further comprises:
comparing a legal person name recognized from the business license photo and a name extracted from the personal identity information of the non-natural person entity operator.

8. The method according to claim 2, wherein the document photo comprises a business license photo and an authorization document photo, and the comparing personal identity information of an authorized non-natural person entity operator recognized from the document photo and the personal identity information of the non-natural person entity operator further comprises:
comparing a non-natural person entity name recognized from the authorization document photo and a non-natural person entity name recognized from the business license photo;
upon determining that the non-natural person entity names are consistent, performing anti-counterfeiting verification on a non-natural person entity official seal recognized from the authorization document photo; and
upon determining that an anti-counterfeiting verification result is “true”, comparing a name of an authorized non-natural person entity operator recognized from the authorization document photo and a name extracted from the personal identity information of the non-natural person entity operator.

9. The method according to claim 1, further comprising:
performing secondary identity verification in response to the authorization confirmation and the non-natural person entity operator continues a service operation.

10-18. (canceled)

19. A non-transitory computer-readable storage medium, wherein when the instructions are executed, a machine is caused to:
receive a service request of the non-natural person entity operator;
obtain personal identity information of the non-natural person entity operator based on the service request, to perform personal identity verification;
obtain and recognize a document photo of a non-natural person entity in response to that personal identity verification succeeds, to perform non-natural person entity identity verification;
in response to that the non-natural person entity identity verification succeeds, confirm that the non-natural person entity operator obtains authorization from the non-natural person entity; and
perform a risk release on the service request based on the authorization confirmation.

20. The non-transitory computer-readable storage medium according to claim 19, wherein the machine being caused to confirm that the non-natural person entity operator obtains authorization from the non-natural person entity includes being caused to:
compare personal identity information of an authorized non-natural person entity operator recognized from the document photo and the personal identity information of the non-natural person entity operator; and
in response to that a comparison result is that the personal identity information of the authorized non-natural person entity operator recognized from the document photo and the personal identity information of the non-natural person entity operator are consistent, confirm that the non-natural person entity operator obtains authorization from the non-natural person entity.

21. An electronic device, comprising a storage, a processor, and a computer program that is stored in the storage and that is capable of running on the processor, wherein when the processor executes the program, the processor is caused to:
receive a service request of the non-natural person entity operator;
obtain personal identity information of the non-natural person entity operator based on the service request, to perform personal identity verification;
obtain and recognize a document photo of a non-natural person entity in response to that personal identity verification succeeds, to perform non-natural person entity identity verification;
in response to that the non-natural person entity identity verification succeeds, confirm that the non-natural person entity operator obtains authorization from the non-natural person entity; and
perform a risk release on the service request based on the authorization confirmation.

22. The electronic device according to claim 21, wherein the electronic device being caused to confirm that the non-natural person entity operator obtains authorization from the non-natural person entity includes being caused to:
compare personal identity information of an authorized non-natural person entity operator recognized from the document photo and the personal identity information of the non-natural person entity operator; and
in response to that a comparison result is that the personal identity information of the authorized non-natural person entity operator recognized from the document photo and the personal identity information of the non-natural person entity operator are consistent, confirm that the non-natural person entity operator obtains authorization from the non-natural person entity.

23. The electronic device according to claim 21, wherein the electronic device being caused to obtain personal identity information of the non-natural person entity operator, to perform personal identity verification includes being caused to:
capture face information and identity document information of the non-natural person entity operator by using a camera, and transfer the face information and the identity document information to an identity verification server; and
perform a three-way comparison on the captured face information, face information extracted from the identity document information, and face information stored in the identity verification server, to perform personal identity verification.

24. The electronic device according to claim 21, wherein the electronic device being caused to obtain and recognize a document photo of a non-natural person entity, to perform non-natural person entity identity verification includes being caused to:
capture the document photo of the non-natural person entity by using a camera, and transfer the document photo to an identity verification server;
perform anti-counterfeiting detection and content recognition on the document photo in the identity verification server, to obtain non-natural person entity document information; and
compare the obtained non-natural person entity document information and non-natural person entity document information stored in the identity verification server, to perform non-natural person entity verification.

25. The electronic device according to claim 24, wherein the electronic device being caused to perform content recognition on the document photo, to obtain non-natural person entity document information includes being caused to:
perform optical character recognition and official seal recognition on the document photo, to obtain the non-natural person entity document information.

26. The electronic device according to claim 21, the electronic device is further caused to:
bind, based on the authorization confirmation, the obtained personal identity information of the non-natural person entity operator to non-natural person entity document information recognized from the document photo of the non-natural person entity, and store the obtained personal identity information and the non-natural person entity document information in the identity verification server.

27. The electronic device according to claim 22, wherein the document photo comprises a business license photo, and the electronic device being caused to compare personal identity information of an authorized non-natural person entity operator recognized from the document photo and the personal identity information of the non-natural person entity operator includes being caused to:
compare a legal person name recognized from the business license photo and a name extracted from the personal identity information of the non-natural person entity operator.

28. The electronic device according to claim 23, wherein the document photo comprises a business license photo and an authorization document photo, and the electronic device being caused to compare personal identity information of an authorized non-natural person entity operator recognized from the document photo and the personal identity information of the non-natural person entity operator includes being caused to:
compare a non-natural person entity name recognized from the authorization document photo and a non-natural person entity name recognized from the business license photo;
upon determining that the non-natural person entity names are consistent, perform anti-counterfeiting verification on a non-natural person entity official seal recognized from the authorization document photo; and
upon determining that an anti-counterfeiting verification result is “true”, compare a name of an authorized non-natural person entity operator recognized from the authorization document photo and a name extracted from the personal identity information of the non-natural person entity operator.

29. The electronic device according to claim 22, the electronic device is further caused to:
perform secondary identity verification in response to the authorization confirmation and the non-natural person entity operator continues a service operation.
